(19) United States
(12) Patent Application Publication
(10) Pub. No.: US 2010/0290184 A1
(43) Pub. Date: Nov. 18, 2010

(54) TEMPERATURE CONTROL APPARATUS, INFORMATION PROCESSING APPARATUS AND METHOD FOR TEMPERATURE CONTROL

(75) Inventor: Michitaka TANI, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/778,034

(22) Filed: May 11, 2010

(30) Foreign Application Priority Data
May 18, 2009 (JP) 2009-119437

(51) Int. Cl. G06F 1/20; F25B 21/02

(52) U.S. Cl. 361/679.54; 62/3.7

(57) ABSTRACT

A temperature control apparatus for controlling a temperature of an electronic device operating with a power supply from a power supply unit, the temperature control apparatus includes a thermoelectric element configured to be serially connected between the power supply unit and the electronic device, and provided at a position where heat generated by the electronic device is transmitted so as to perform a temperature control over the electronic device with the power supplied from the power supply unit.

### CROSS-REFERENCE TO RELATED APPLICATIONS

This application is based upon and claims the benefit of priority of the prior Japanese Patent Application No. 2009-119437, filed on May 18, 2009, the entire contents of which are incorporated herein by reference.

### FIELD

The embodiments discussed herein are related to a temperature control apparatus, an information processing apparatus and a method for temperature control.

### BACKGROUND

Some devices may generate heat in operating, such as an LSI (Large Scale Integrated circuit) in a CPU (Central Processing Unit) that may be a processor within a computer functioning as an information processing apparatus. Cooling those devices is important in order to satisfy an operating temperature condition of the computer. Thermoelectric elements such as a Peltier device have been known as elements that cool a heat generating member such as a CPU by using the Peltier effect. A Peltier device has a higher heat exchange characteristic and may cool or heat as a result of the change in polarities of the electrodes of the Peltier device. An electronic device that generates heat, such as an LSI in a CPU, and for which temperature control is important will be called a controlled object hereinafter.

There are Japanese Laid-open Patent Publication Nos. 2008-198671, 2005-72218 and 10-14766 as reference documents. There is also Laid-open Japanese Utility Model Publication No. 7-5241 as a reference document.

The repeated heating and cooling may cause thermal cycle fatigue, for example, a failure at the joining of the Peltier device and a lead and thus results in inoperability. When a Peltier device has such a problem and a cooling function of the Peltier device terminates, the Peltier device may become a high thermal resistance to the controlled object and possibly cause a misoperation by or a malfunction in the controlled object.

### SUMMARY

According to an aspect of the embodiment, a temperature control apparatus for controlling a temperature of an electronic device operating with a power supply from a power supply unit, the temperature control apparatus includes a thermoelectric element configured to be serially connected between the power supply unit and the electronic device, and provided at a position where heat generated by the electronic device is transmitted so as to perform a temperature control over the electronic device with the power supplied from the power supply unit.

According to an another aspect of the embodiment, an information processing apparatus includes a processing unit that processes data, a power supply unit that supplies a power to the processing unit, and a thermoelectric element serially connected between the power supply unit and the processing unit, and provided at a position where heat generated by the processing unit is transmitted so as to perform a temperature control over the processing unit with the power supplied from the power supply unit.

According to an another aspect of the embodiment, a temperature control method for controlling a temperature of an information processing apparatus including a processing unit, the temperature control method includes supplying a power from a power supply unit to the processing unit, detecting a temperature of the processing unit by a temperature detector, controlling the power supplied from the power supply unit to the processing unit by a thermoelectric element, the thermoelectric element serially connected between the power supply unit and the processing unit, and provided at a position where heat generated by the processing unit is transmitted, and controlling a direction of current to be supplied from the power supply unit to maintain the temperature of the electronic device within a predetermined temperature range and controlling a direction of current to be supplied to the electronic device to maintain the direction for a period of time when the direction of current to be supplied from the power supply unit is changed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a temperature control apparatus.

FIGS. 2A and 2B illustrate the directions of current in the temperature control apparatus.

FIGS. 3A and 3B illustrate examples of the attachment and removal between a Peltier device and a controlled object.

FIG. 4 is a flowchart illustrating operations involved in a heat control by the temperature control apparatus.

FIG. 5 illustrates an example of an information processing apparatus including the temperature control apparatus.

### DESCRIPTION OF EMBODIMENTS

Preferred embodiments of the present techniques will be explained with reference to accompanying drawings.

According to the embodiments of the present techniques, a Peltier device is provided in series in a power supply line for a controlled object and is used as a fuse as well as a heat exchanger.

Soldering, for example, may often be used for jointing a wiring lead and a Peltier device in an apparatus. However, with repeated thermal cycles, the heat stress may easily cause a joining failure. The caused joining failure inhibits the energization of the Peltier device, and, in turn, terminates the cooling function for a temperature-controlled object by the Peltier device. Thus, in some cases, the temperature of the controlled object may rapidly reach a high temperature. The failing Peltier device may become a thermal resistance to the controlled object and cause a misoperation by or a malfunction in the controlled object.

According to the embodiment, a Peltier device and a controlled object are serially connected to a power supply unit, whereby the Peltier device functions as a fuse and the controlled object functions as a load. When the heat stress causes a joining failure between the Peltier device and the lead, the Peltier device works as a fuse, and the power supply to the controlled object may be terminated. This may prevent misoperations by or malfunctions in the controlled object which may be caused by the high thermal resistance of the failing Peltier device.

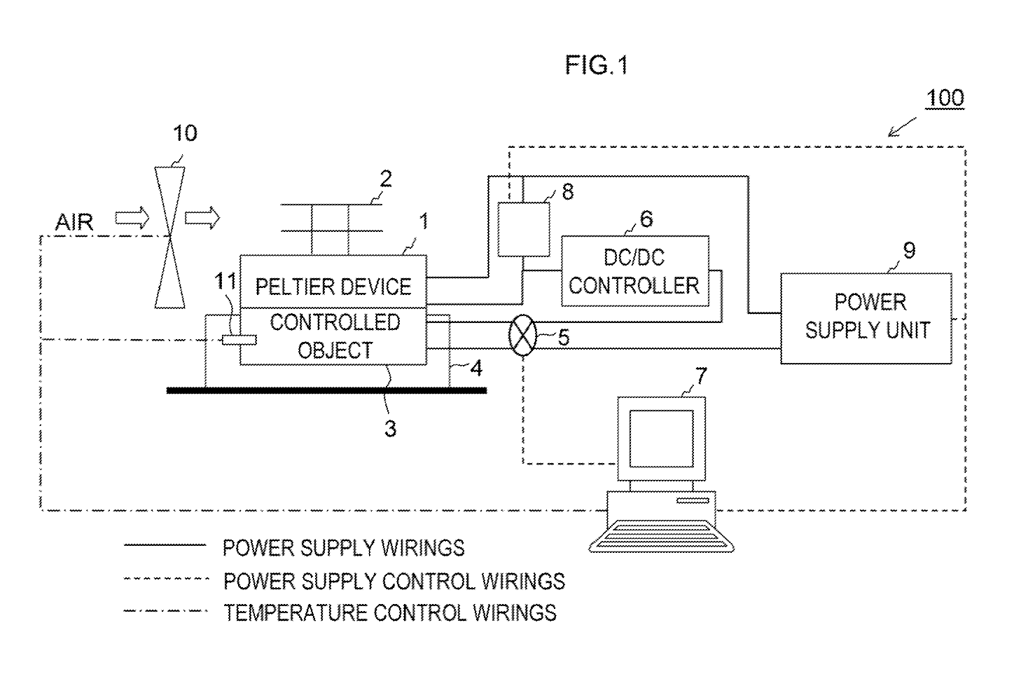

FIG. 1 illustrates a temperature control apparatus according to the embodiment. A temperature control apparatus 100 includes a Peltier device 1, a cooling fin 2, a controlled object 3, a jig 4, a power-supply-control relay circuit 5 (relay circuit), a DC/DC controller 6, a controller 7, a voltmeter 8, a power supply unit 9, a fan 10, and a temperature sensor 11.

The Peltier device 1 is a semiconductor device formed by jointing different types of metal. When current is fed to the Peltier device 1, one surface of the Peltier device 1 causes heat absorption while the other surface causes heat generation. Changing the polarity of the power supply causes the Peltier device 1 to reverse the heat-absorbing surface for cooling and the heat-generating surface for heating.

The cooling fin 2 is jointed with the Peltier device 1 and thus improves the efficiency of heat radiation by the Peltier device 1. The controlled object 3 may be an LSI in a CPU, for example, and is an object to be controlled in temperature. The jig 4 fixes the controlled object 3 to a predetermined position. The power-supply-control relay circuit 5 is a switching circuit that keeps the direction of the current (or the polarity of the power supply) to the controlled object 3 in a predetermined direction even when the polarities of the power supply unit 9 is reversed. The power-supply-control relay circuit 5 is driven in accordance with a control instruction from the controller 7.

The DC/DC controller 6 converts the voltage supplied from the power supply unit 9 to a voltage enough for operating the Peltier device 1 and converts the supplied voltage to a voltage enough for operating the controlled object 3. On the basis of the measured values by the voltmeter 8 and temperature sensor 11, the controller 7 controls the fan 10 and power-supply-control relay circuit 5 and changes the polarities of the power supply unit 9. On the basis of the values of three elements of deviation, integration and differentiation between the output value and a target value, the controller 7 performs temperature control such as PID (proportional integral differential) control that is one of the control methods based on feedbacks for control over input values.

The voltmeter 8 is a measuring instrument that measures a voltage between terminals of the Peltier device 1. The power supply unit 9 supplies power for operating the Peltier device 1 and the controlled object 3. On the basis of a control instruction from the controller 7, the power supply unit 9 may reverse the polarity of the power supply to apply reverse voltage to a load.

On the basis of a control instruction from the controller 7, the fan 10 sends air to the Peltier device 1 and cooling fin 2 and transmits heat from the Peltier device 1 to the outside. The temperature sensor 11 measures the present temperature of the controlled object 3. The measured temperature value is notified to the controller 7.

The solid lines in FIG. 1 indicate wirings that supply power. The broken lines in FIG. 1 indicate wirings for a control signal that control the direction of power supply (or direction of current). The alternate long and short dashed lines in FIG. 1 indicate wirings for a control signal that control a temperature. The Peltier device 1 and the controlled object 3 are serially connected and receive power supply from the same power source, the power supply unit 9.

Like the temperature control apparatus 100 in FIG. 1, the serial connection of the Peltier device 1 and controlled object 3 to the power supply unit allows simultaneous forced termination of the entire system employing the controlled object 3 even when an open fault occurs in the Peltier device 1 and the function terminates. Thus, the fault due to the heat of the entire system may be avoided.

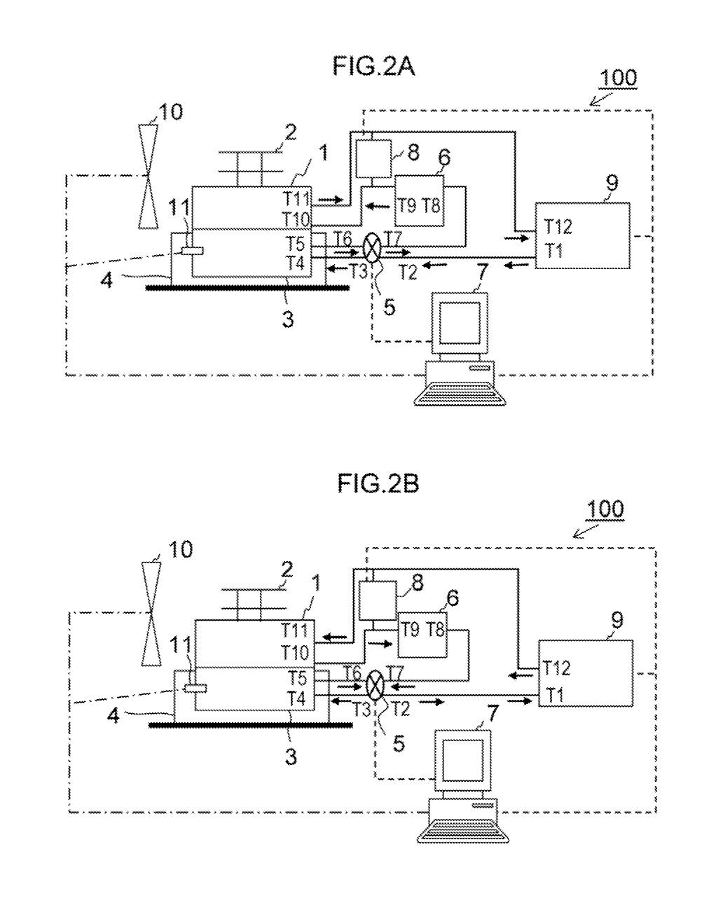

Next, with reference to FIGS. 2A and 2B, there will be described the direction of power supply to the temperature control apparatus 100 according to the embodiment. The arrows in FIG. 2A indicate the direction of power supply to the Peltier device 1 that cools the controlled object 3. The arrows in FIG. 2B indicate the direction of power supply to the Peltier device 1 that heats the controlled object 3. FIGS. 2A and 2B illustrate terminals T1 to T12 of the illustrated units for connecting to the wirings. The direction of current may be changed by the reverse of the voltage polarities of the terminals T1 and T12 of the power supply unit 9.

In the example in FIG. 2A, current starts flowing from the terminal T1 of the power supply unit 9, further flows sequentially to the terminals T2 and T3 of the power-supply-control relay circuit 5, the terminals T4 and T5 of the controlled object 3, the terminals T6 and T7 of the power-supply-control relay circuit 5, the terminals T8 and T9 of the DC/DC controller 6 and the terminals T10 and T11 of the Peltier device 1 and finally reaches the terminal T12 of the power supply unit 9. According to the embodiment, when current flows in the direction from the terminal T10 to the terminal T11 of the Peltier device 1, the surface on the controlled object 3 side of the Peltier device 1 absorbs heat, and the other surface (on the cooling fin 2 side) generates heat.

The switching control over the electrodes of the power supply unit 9 and switching control over the wirings of the power-supply-control relay circuit 5 by the controller 7 change the direction of the current to the direction illustrated in FIG. 2B. In other words, the current starts flowing from the terminal T12 of the power supply unit 9, flows through the terminals T11 and T10 of the Peltier device 1 and the terminals T9 and T8 of the DC/DC controller 6 and reaches the terminal T7 of the power-supply-control relay circuit 5.

The power-supply-control relay circuit 5 here controls the current so as to flow from the terminal T3 in order to keep the voltage polarity to the controlled object 3. Then, the current sequentially flows to the terminals T4 and T5 of the controlled object 3, reaches the terminal T6 of the power-supply-control relay circuit 5 and finally flows through the terminal T2 of the power-supply-control relay circuit 5 to the terminal T1 of the power supply unit 9. In this way, the Peltier device 1 may function as the opposite electrode, which causes the current to flow from the terminal T11 to the terminal T10 of the Peltier device 1. The surface on the controlled object 3 side of the Peltier device 1 generates heat, and the other surface absorbs heat.

In this way, for example, in operating the system in a cold climate area, the Peltier device may be used as a heater by the use of the characteristic of the Peltier device and the application of reverse voltage.

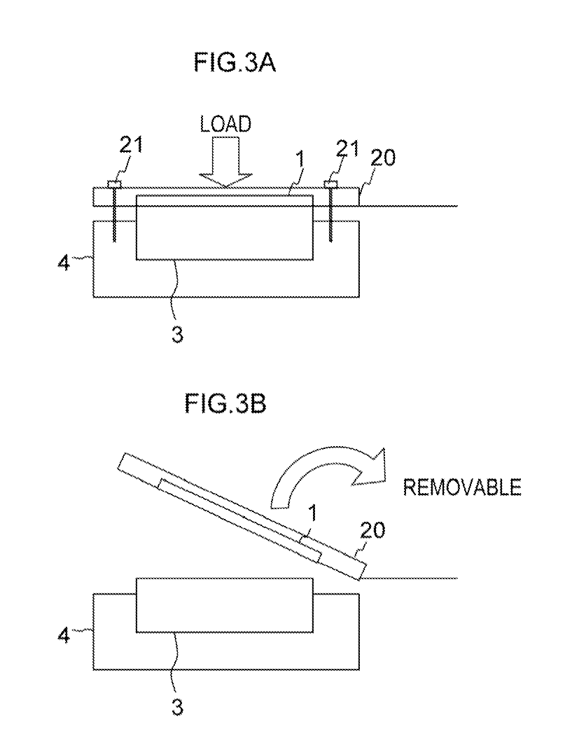

Next, the attachment and removal of the Peltier device 1 to and from the controlled object 3 will be described with reference to FIGS. 3A and 3B.

In normal use, a thermal compound is provided between the controlled object 3 and the Peltier device 1, and the controlled object 3 and the Peltier device 1 are brought into intimate contact by minimizing the thermal resistance and applying a load between them for temperature control. For example, as in the example in FIG. 3A, a heat-resistant material 20 is provided around the Peltier device 1, and the heat-resistant material 20 and the jig 4 are fixed with screws 21 so that the controlled object 3 and the Peltier device 1 may be bought into intimate contact.

In maintenance such as replacement of the Peltier device 1, the load is removed so that the Peltier device 1 may be removed from the controlled object 3 easily. (Refer to FIG. 3B).

Thus, the use of the Peltier device 1 as a fuse allows easy replacement of the Peltier device 1 and improves the efficiency of maintenance if a joining failure occurs at the joining of the Peltier device 1 and wirings.

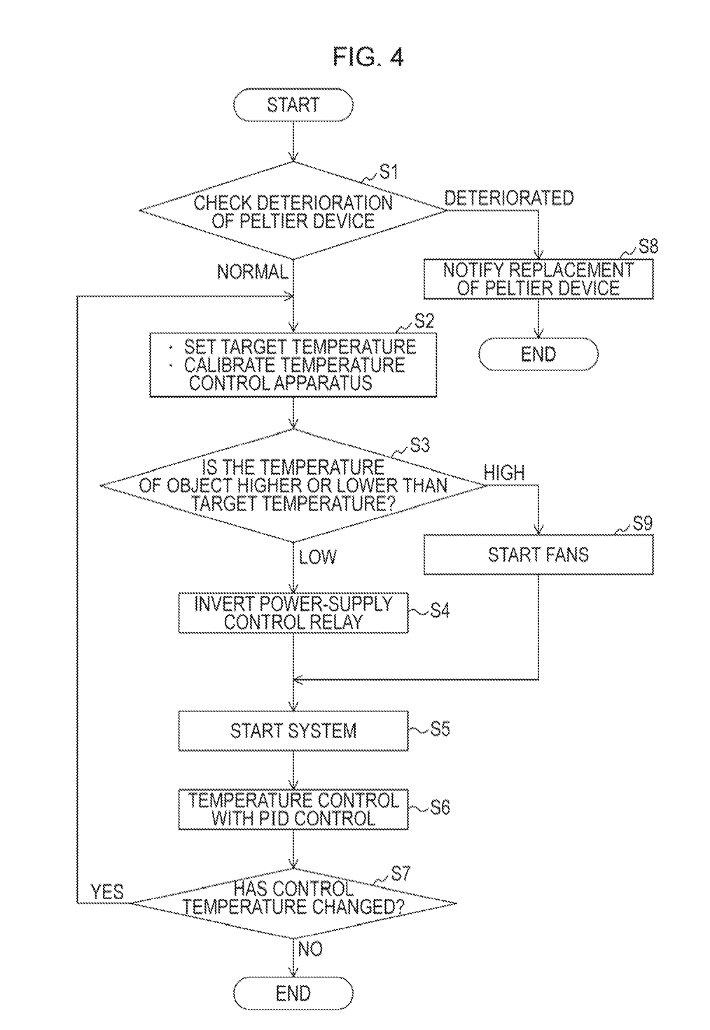

Next, a temperature control method by the temperature control apparatus 1 will be described with reference to the flowchart illustrated in FIG. 4. The initial settings of the temperature control apparatus 100 include the direction illustrated in FIG. 2A of the power supply by the power supply unit 9, that is, the direction for cooling the controlled object 3 by the Peltier device 1.

First, the controller 7 acquires the value of the voltage drop within the Peltier device 1 from the voltmeter 8 and determines whether the value is within a predefined range of voltage drop values or not to check whether the Peltier device 1 is deteriorated or not (S1). If it is determined that the Peltier device 1 is deteriorated (“deteriorated” in S1), the controller 7 notifies the need for replacement of the Peltier device 1 to a user (S8). For example, the controller 7 may emit a predetermined warning sound or display a predetermined character string such as a warning message on a display if any, for the user notification.

If it is determined that the Peltier device 1 is not deteriorated (“normal” in S1), the controller 7 retrieves a predefined target temperature (such as a normal temperature of 24° C.) of the controlled object 3 from a storage portion of the controller 7 or from an external storage and calibrates the entire temperature control apparatus 100 (S2).

Next, the controller 7 acquires the temperature value measured by the temperature sensor 11 and determines whether the present temperature of the controlled object 3 is higher than the target temperature or not (S3). If the present temperature of the controlled object 3 is equal to or higher than the target temperature (“high temperature” in S3), the system is started (with the initial settings), in order to cool the controlled object 3, so that the surface on the controlled object 3 side of the Peltier device 1 may be the heat-absorbing surface and the surface on the cooling fin 2 side may be the heat-generating surface. In order to release the heat on the cooling fin 2 side to the outside, the controller 7 starts the fan 10 (S9).

If, on the other hand, the present temperature of the controlled object 3 is lower than the target temperature (“low temperature” in S3), the controller 7 performs, in order to enable the heater function of the Peltier device 1, control for reverse of the electrodes of the power supply unit 9 and control over the power-supply-control relay circuit 5. Thus, the direction of power supply by the power supply unit 9 may be changed to the direction in FIG. 2B, that is, the direction in which the controlled object 3 is heated by the Peltier device 1 (S4).

After that, the power supply by the power supply unit 9 starts the controlled object 3 and starts the entire system (S5). While the system is running, the controller 7 performs the temperature control by PID control, for example (S6). If the temperature of the controlled object 3 changes (Yes in S7), the processing returns to S2. If the system has already been started, the processing in S5 is omitted.

Having described that the processing in S3 determines whether the temperature of the controlled object 3 is higher than the target temperature or not, the processing in S3 may determine whether the temperature of the controlled object 3 is within a predetermined tolerance or not. For example, if the temperature of the controlled object 3 is beyond the tolerance, the controller 7 may start the fan 10. If the temperature is below the tolerance, the controller 7 may control the direction of the power supply such that the Peltier device 1 may heat the controlled object 3.

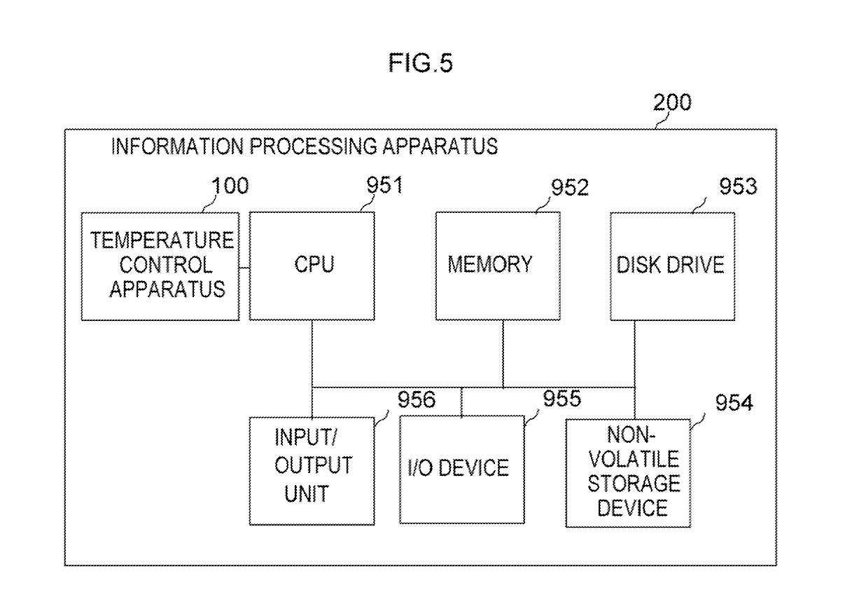

Finally, an information processing apparatus including the temperature control apparatus 100 will be described with reference to FIG. 5. An information processing apparatus 200 includes a CPU 951 that is a processor controller, a memory 952 that is a main storage device, and a disk drive 953 that accommodates a storage medium such as a CD-ROM and reads and writes data. The information processing apparatus 200 further includes a non-volatile storage device 954 that is a non-volatile storage device such as a magnetic disk device and a flash memory and an I/O device 955 that allows and controls data communication with an external device. The information processing apparatus 200 further includes an input/output unit 956 such as a display and a keyboard that receives inputs from a user.

The temperature control apparatus 100 is connected to the CPU 951. In other words, the temperature control apparatus 100 in the example in FIG. 4 performs the temperature control over the CPU 951 by handling the CPU 951 as the controlled object.

The controller 7 may be implemented by the combination of a hardware resource such as the CPU 951 and the memory 952 within the information processing apparatus 200 and firmware within the non-volatile storage device 954. Alternatively, a CPU, a memory and a non-volatile storage device, not illustrated, specific to the aforementioned functions of the controller 7 may be prepared separately, and the controller 7 may be implemented by the combination of the hardware and firmware within the non-volatile storage device.

As in the embodiment, the serial connection of the controlled object and the Peltier device and the use of the Peltier device as a fuse allow the termination of the controlled object 3 if a joining failure occurs at the joining between the Peltier device and wirings. In other words, the entire apparatus (such as the information processing apparatus 200) operated by the controlled object 3 may be terminated. This may prevent a misoperation and/or malfunction due to thermal runaway of the controlled object.

The temperature control apparatus and information processing apparatus according to the embodiment and the temperature control method disclosed according to the embodiment have the following effects. That is, the risk of faults occurring when a Peltier device is used may be avoided, and the temperature control is allowed that may more quickly cool an object than air cooling based on general temperature control methods. The ease of control over cooling and heating may reduce the constraint on temperature environment where the object is used.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A temperature control apparatus for controlling a temperature of an electronic device operating with a power supply from a power supply unit, the temperature control apparatus comprising:
a thermoelectric element configured to be serially connected between the power supply unit and the electronic device, and provided at a position where heat generated by the electronic device is transmitted so as to perform a temperature control over the electronic device with the power supplied from the power supply unit.

2. The temperature control apparatus according to claim 1, further comprising:
a temperature detector that detects a temperature of the electronic device; and
a power controller that controls a direction of current to be supplied from the power supply unit to maintain the temperature of the electronic device within a predetermined temperature range and that controls a direction of current to be supplied to the electronic device to maintain the direction for a period of time when the direction of current to be supplied from the power supply unit is changed.

3. The temperature control device according to claim 1, further comprising:
a voltage detector that detects a voltage applied to the thermoelectric element, wherein the power controller notifies external of the temperature control device when the voltage detector detects voltage outside a predetermined voltage range.

4. The temperature control device according to claim 2, further comprising:
a cooling unit that cools the thermoelectric element when the temperature detector detects temperature beyond the predetermined temperature range.

5. An information processing apparatus comprising:
a processing unit that processes data;
a power supply unit that supplies a power to the processing unit; and
a thermoelectric element serially connected between the power supply unit and the processing unit, and provided at a position where heat generated by the processing unit is transmitted so as to perform a temperature control over the processing unit with the power supplied from the power supply unit.

6. The information processing apparatus according to claim 5, further comprising:
a temperature detector that detects a temperature of the processing unit; and
a power controller that controls a direction of current to be supplied from the power supply unit to maintain the temperature of the electronic device within a predetermined temperature range and that controls a direction of current to be supplied to the electronic device to maintain the direction for a period of time when the direction of current to be supplied from the power supply unit is changed.

7. The information processing apparatus according to claim 5, further comprising:
a voltage detector that detects a voltage applied to the thermoelectric element, wherein the power controller notifies external of the temperature control device when the voltage detector detects voltage outside a predetermined voltage range.

8. The information processing apparatus according to claim 6, further comprising:
a cooling unit that cools the thermoelectric element when the temperature detector detects temperature beyond the predetermined temperature range.

9. A temperature control method for controlling a temperature of an information processing apparatus including a processing unit, the temperature control method comprising:
supplying a power from a power supply unit to the processing unit;
detecting a temperature of the processing unit by a temperature detector;
controlling the power supplied from the power supply unit to the processing unit by a thermoelectric element, the thermoelectric element serially connected between the power supply unit and the processing unit, and provided at a position where heat generated by the processing unit is transmitted; and
controlling a direction of current to be supplied from the power supply unit to maintain the temperature of the electronic device within a predetermined temperature range and controlling a direction of current to be supplied to the electronic device to maintain the direction for a period of time when the direction of current to be supplied from the power supply unit is changed.

10. The temperature control method according to claim 9, further comprising:
detecting a voltage applied to the thermoelectric element by a voltage detector; and
notifying external of the temperature control device by the power controller when the voltage detector detects voltages outside a predetermined voltage range.

11. The temperature control method according to claim 9, further comprising:
cooling the thermoelectric element by a cooling unit when the temperature detector detects a temperature beyond the predetermined temperature range.
